(19) United States
(12) Patent Application Publication
(10) Pub. No.: US 2023/0001914 A1
(43) Pub. Date: Jan. 5, 2023

(54) Device and Method for Controlling Autonomous Driving

(71) Applicants: Hyundai Motor Company, Seoul (KR); Kia Corporation, Seoul (KR)

(72) Inventor: Jung Wan Kim, Yongin-si (KR)

(21) Appl. No.: 17/734,463

(22) Filed: May 2, 2022

(30) Foreign Application Priority Data
Jul. 5, 2021 (KR) 10-2021-0088005

(51) Int. Cl. B60W 30/04; B60W 60/00; B60W 40/112; B60W 10/04; B60W 10/18; B60W 30/12; B60W 30/18

(52) U.S. Cl. CPC B60W 30/04; B60W 60/001; B60W 40/112; B60W 10/04; B60W 10/18; B60W 30/12; B60W 30/18163; B60W 2530/10; B60W 2520/10; B60W 2520/18; B60W 2510/222; B60W 2030/043

(57) ABSTRACT

An embodiment device for controlling autonomous driving includes a roll angle estimated value calculation device configured to calculate a roll angle estimated value of a vehicle based on a height of a center of gravity of the vehicle, a sprung mass, a spring constant of a suspension, a target speed, and a target turning radius, and a controller configured to compare a roll angle of the vehicle with a preset reference roll angle to adjust the target speed or the target turning radius of the vehicle.

### CROSS-REFERENCE TO RELATED APPLICATIONS

This application claims the benefit of Korean Patent Application No. 10-2021-0088005, filed on Jul. 5, 2021, which application is hereby incorporated herein by reference.

### TECHNICAL FIELD

The present disclosure relates to a device and a method for controlling autonomous driving.

### BACKGROUND

An autonomous vehicle is required to have an ability to adaptively cope with a surrounding situation that changes in real time during travel.

For mass production and invigoration of the autonomous vehicle, a reliable determination control function is required above all.

Semi-autonomous vehicles that have been recently released basically perform driving, braking, and steering on behalf of a driver to reduce fatigue of the driver.

In a case of semi-autonomous driving, unlike fully autonomous driving, the driver has to stay focused on driving such as continuously holding a steering wheel and the like.

Recently, the semi-autonomous vehicles are being sold with a highway driving assist (HDA) function, a driver status warning (DSW) function that determines driver carelessness and state abnormalities such as drowsy driving, distraction, and the like to output a warning alarm through a cluster and the like, a driver awareness warning (DAW) function that determines whether the vehicle crosses a line and travels unstably through a front camera and the like, a forward collision-avoidance assist (FCA) or an active emergency brake system (AEBS) function that performs sudden braking when detecting a forward collision, and the like.

A logistics transportation technology of an autonomous driving truck may be being actively developed to solve problems such as a manpower shortage, environmental pollution, fuel efficiency, and the like that the cargo transportation industry is facing recently. In addition, a possibility of mass production of the logistics transportation technology of the autonomous driving truck is also increasing. In a logistics system using such an autonomous driving truck, research focusing on energy efficiency and fast movement is in progress. Further, in a case of a truck with a relatively high center of gravity of the vehicle, when transporting a lot of cargo, because the truck is vulnerable to rolling during traveling in a turning section, braking for securing safety may simultaneously lower the energy efficiency and cause delivery time delay. In a case of the autonomous driving truck for unmanned logistics transportation, because there is no need to consider comfort of an occupant, a need for a method for securing energy efficiency and fast movement using this within a range where vehicle overturning stability is ensured is emerging.

### SUMMARY

The present disclosure relates to a device and a method for controlling autonomous driving. Particular embodiments relate to a device and a method for controlling an autonomous vehicle for logistics transportation.

Embodiments of the present disclosure can solve problems occurring in the prior art while advantages achieved by the prior art are maintained intact.

An embodiment of the present disclosure provides a device and a method for controlling an autonomous vehicle for logistics transportation.

Another embodiment of the present disclosure provides a device and a method for controlling an autonomous vehicle that may calculate a roll angle of the autonomous vehicle for logistics transportation to perform autonomous driving that secures vehicle overturning stability.

Another embodiment of the present disclosure provides a device and a method for controlling an autonomous vehicle that may perform lateral or longitudinal autonomous driving control of the vehicle based on a roll angle of the autonomous vehicle to promote an increase in energy efficiency and a reduction in transportation time.

Another embodiment of the present disclosure provides a device and a method for controlling an autonomous vehicle that may reduce a logistics cost through an increase in energy efficiency and a reduction in transportation time of the autonomous vehicle for logistics transportation.

Another embodiment of the present disclosure provides a device and a method for controlling an autonomous vehicle that may allow an autonomous vehicle to maintain a minimum turning radius in a rolling safe region when traveling at a turning reference speed to ensure a minimum traveling distance, thereby promoting logistics cost optimization together with speed limitation.

The technical problems to be solved by embodiments of the present inventive concept are not limited to the aforementioned problems, and any other technical problems not mentioned herein will be clearly understood from the following description by those skilled in the art to which the present disclosure pertains.

According to an embodiment of the present disclosure, a device for controlling autonomous driving includes a roll angle estimated value calculation device that calculates a roll angle estimated value of an autonomous vehicle based on a height of a center of gravity of the autonomous vehicle, a sprung mass, a spring constant of a suspension, a target speed, and a target turning radius, and a controller that compares a roll angle of the autonomous vehicle with a preset reference roll angle to adjust at least one of the target speed and/or the target turning radius of the autonomous vehicle.

In one implementation, the device may further include a reference roll angle calculation device that calculates the reference roll angle based on a threshold of rollover of the autonomous vehicle determined based on the height of the center of gravity and a wheel tread of the autonomous vehicle.

In one implementation, the controller may decrease the target speed when the roll angle estimated value is greater than the reference roll angle, maintain the target speed when the roll angle estimated value is equal to the reference roll angle, and maintain the target speed when the roll angle estimated value is smaller than the reference roll angle.

In one implementation, the controller may increase the target turning radius when the roll angle estimated value is greater than the reference roll angle and a lane change is possible, maintain the target turning radius when the roll angle estimated value is equal to the reference roll angle, and decrease the target turning radius when the roll angle estimated value is smaller than the reference roll angle and the lane change is possible.

In one implementation, the controller may maintain the target turning radius when a lane change is impossible.

In one implementation, the controller may compare the target speed with a speed of the autonomous vehicle to control at least one of a drive torque and/or a braking torque of the autonomous vehicle, or compare the target turning radius with a turning radius corresponding to a current traveling line of the autonomous vehicle to perform lane change control or lane maintenance control of the autonomous vehicle.

In one implementation, the controller may increase the drive torque when the target speed is higher than the speed of the autonomous vehicle, maintain the drive torque when the target speed is equal to the speed of the autonomous vehicle, and reduce the drive torque when the target speed is lower than the speed of the autonomous vehicle.

In one implementation, the controller may increase the braking torque when the target speed is lower than the speed of the autonomous vehicle.

In one implementation, the controller may perform the lane change control in a direction to decrease a turning radius when the target turning radius is smaller than the turning radius corresponding to the current traveling line, perform the lane maintenance control when the target turning radius is equal to the turning radius corresponding to the current traveling line, and perform the lane change control in a direction to increase the turning radius when the target turning radius is larger than the turning radius corresponding to the current traveling line.

In one implementation, the roll angle estimated value calculation device may set a speed value input from a user as an initial value of the target speed, set a minimum turning radius of a preceding section of a traveling road of the autonomous vehicle as an initial value of the target turning radius, and receive feedback of at least one of the target speed and/or the target turning radius from the controller.

In one implementation, the roll angle estimated value calculation device may calculate the roll angle estimated value of the autonomous vehicle to be proportional to a lateral acceleration determined based on the target speed and the target turning radius, the sprung mass, and the height of the center of gravity, and to be inversely proportional to the spring constant.

In one implementation, the reference roll angle calculation device may calculate the reference roll angle to be proportional to a preset safety factor and the wheel tread, and to be inversely proportional to the height of the center of gravity.

According to another embodiment of the present disclosure, a method for controlling autonomous driving includes calculating, by a roll angle estimated value calculation device, a roll angle estimated value of an autonomous vehicle based on a height of a center of gravity of the autonomous vehicle, a sprung mass, a spring constant of a suspension, a target speed, and a target turning radius, and adjusting, by a controller, at least one of the target speed and/or the target turning radius of the autonomous vehicle by comparing a roll angle of the autonomous vehicle with a preset reference roll angle.

In one implementation, the method may further include calculating, by a reference roll angle calculation device, the reference roll angle based on a threshold of rollover of the autonomous vehicle determined based on the height of the center of gravity and a wheel tread of the autonomous vehicle.

In one implementation, the adjusting, by the controller, of at least one of the target speed and/or the target turning radius of the autonomous vehicle may include decreasing, by the controller, the target speed when the roll angle estimated value is greater than the reference roll angle, maintaining, by the controller, the target speed when the roll angle estimated value is equal to the reference roll angle, and maintaining, by the controller, the target speed when the roll angle estimated value is smaller than the reference roll angle.

In one implementation, the adjusting, by the controller, of at least one of the target speed and/or the target turning radius of the autonomous vehicle may include increasing, by the controller, the target turning radius when the roll angle estimated value is greater than the reference roll angle and lane change is possible, maintaining, by the controller, the target turning radius when the roll angle estimated value is equal to the reference roll angle, decreasing, by the controller, the target turning radius when the roll angle estimated value is smaller than the reference roll angle and the lane change is possible, and maintaining, by the controller, the target turning radius when the lane change is impossible.

In one implementation, the method may further include comparing, by the controller, the target speed with a speed of the autonomous vehicle to control at least one of a drive torque and/or a braking torque of the autonomous vehicle, or comparing the target turning radius with a turning radius corresponding to a current traveling line of the autonomous vehicle to perform lane change control or lane maintenance control of the autonomous vehicle.

In one implementation, the controlling, by the controller, of at least one of the drive torque and/or the braking torque of the autonomous vehicle, or the performing of the lane change control or the lane maintenance control of the autonomous vehicle may include increasing, by the controller, the drive torque when the target speed is higher than the speed of the autonomous vehicle, maintaining, by the controller, the drive torque when the target speed is equal to the speed of the autonomous vehicle, and reducing, by the controller, the drive torque or increasing the braking torque when the target speed is lower than the speed of the autonomous vehicle.

In one implementation, the controlling, by the controller, of at least one of the drive torque and/or the braking torque of the autonomous vehicle, or the performing of the lane change control or the lane maintenance control of the autonomous vehicle may include performing, by the controller, the lane change control in a direction to decrease a turning radius when the target turning radius is smaller than the turning radius corresponding to the current traveling line, performing, by the controller, the lane maintenance control when the target turning radius is equal to the turning radius corresponding to the current traveling line, and performing, by the controller, the lane change control in a direction to increase the turning radius when the target turning radius is larger than the turning radius corresponding to the current traveling line.

In one implementation, the calculating, by the roll angle estimated value calculation device, of the roll angle estimated value of the autonomous vehicle may include calculating, by the roll angle estimated value calculation device, a roll angle estimated value of the autonomous vehicle to be proportional to a lateral acceleration determined based on the target speed and the target turning radius, the sprung mass, and the height of the center of gravity, and to be inversely proportional to the spring constant, and the calculating, by the reference roll angle calculation device, of the reference roll angle may include calculating, by the reference roll angle calculation device, the reference roll angle to be proportional to a preset safety factor and the wheel tread, and to be inversely proportional to the height of the center of gravity.

### BRIEF DESCRIPTION OF THE DRAWINGS

The above and other objects, features and advantages of embodiments of the present disclosure will be more apparent from the following detailed description taken in conjunction with the accompanying drawings, in which:

FIG. 1 is a table in which automation levels of an autonomous vehicle are defined;

FIG. 2 is a block diagram showing an autonomous driving control device according to an embodiment of the present disclosure;

FIG. 3 is a block diagram showing an autonomous driving control device according to another embodiment of the present disclosure;

FIG. 4 is a view showing a roll angle estimated value calculation device according to an embodiment of the present disclosure;

FIG. 5 is a view showing a reference roll angle calculation device according to an embodiment of the present disclosure;

FIG. 6 is a view showing a controller according to an embodiment of the present disclosure;

FIG. 7 is a view showing a rollover threshold according to an embodiment of the present disclosure;

FIG. 8 is a flowchart showing an autonomous driving control method according to an embodiment of the present disclosure;

FIG. 9 is a flowchart showing an autonomous driving control method according to another embodiment of the present disclosure; and

FIG. 10 is a flowchart showing an autonomous driving control method according to another embodiment of the present disclosure.

### DETAILED DESCRIPTION OF ILLUSTRATIVE EMBODIMENTS

Hereinafter, some embodiments of the present disclosure will be described in detail with reference to the exemplary drawings. In adding the reference numerals to the components of each drawing, it should be noted that the identical or equivalent component is designated by the identical numeral even when it is displayed on other drawings. Further, in describing the embodiments of the present disclosure, a detailed description of well-known features or functions will be omitted in order not to unnecessarily obscure the gist of the present disclosure.

In describing the components of the embodiments according to the present disclosure, terms such as first, second, “A”, “B”, (a), (b), and the like may be used. These terms are merely intended to distinguish one component from another component, and the terms do not limit the nature, sequence or order of the constituent components. Unless otherwise defined, all terms used herein, including technical or scientific terms, have the same meanings as those generally understood by those skilled in the art to which the present disclosure pertains. Such terms as those defined in a generally used dictionary are to be interpreted as having meanings equal to the contextual meanings in the relevant field of art, and are not to be interpreted as having ideal or excessively formal meanings unless clearly defined as having such in the present application.

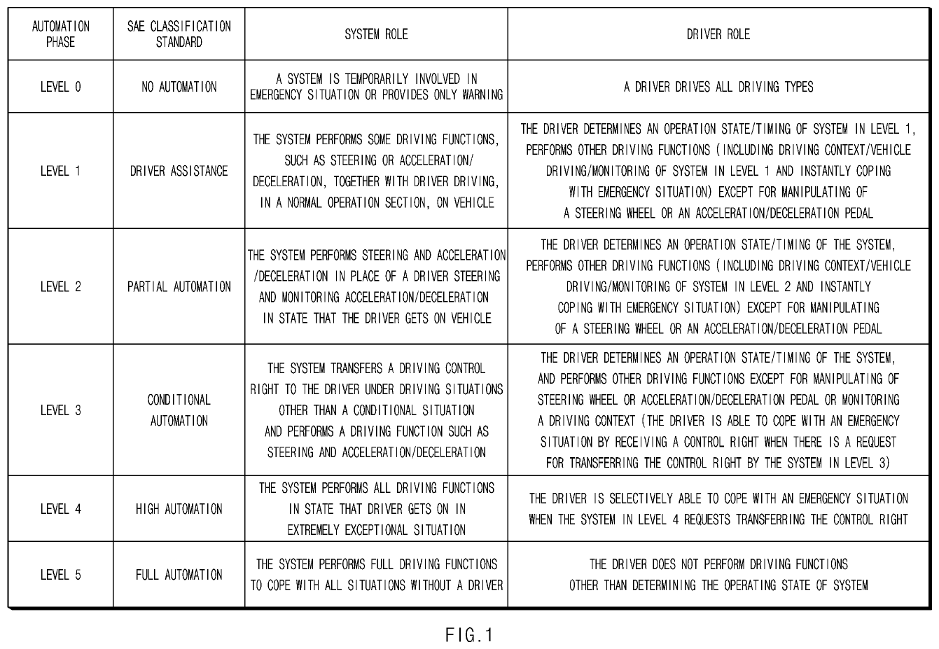

Hereinafter, embodiments of the present disclosure will be described in detail with reference to FIGS. 1 to 8.

FIG. 1 is a table in which automation levels of an autonomous vehicle are defined.

The autonomous vehicle refers to a vehicle that recognizes a travel environment by itself to determine a risk, minimizes travel manipulation of a driver while controlling a travel route, and drives by itself.

Ultimately, the autonomous vehicle refers to a vehicle capable of traveling, controlling, and parking without an influence of humans, and is focused on a vehicle in a state in which an autonomous driving technology, which is a core foundation of the autonomous vehicle, that is, an ability to operate the vehicle without active control or monitoring of the driver is the most advanced.

Referring to FIG. 1, in an automation step level 0 to 2, the travel environment is monitored by the driver. On the other hand, in an automation step level 3 to 5, the travel environment is monitored by an automated travel system.

However, a concept of the autonomous vehicle currently being released may include an automation step of an intermediate step to the autonomous vehicle in a full sense, and corresponds to a goal-oriented concept on the premise of mass production and commercialization of a fully autonomous vehicle.

An autonomous driving control method according to embodiments of the present disclosure may be applied to an autonomous vehicle corresponding to the level 2 (partial autonomous driving) and the level 3 (conditional autonomous driving) among automation steps of the autonomous driving shown in FIG. 1. However, embodiments of the present disclosure may not be necessarily limited thereto, and the autonomous driving control method may be applied to an autonomous vehicle supporting a plurality of various automation steps.

The automation level of the autonomous vehicle based on the society of automotive engineers (SAE), which is an American association of automotive engineers, may be classified as shown in the table in FIG. 1.

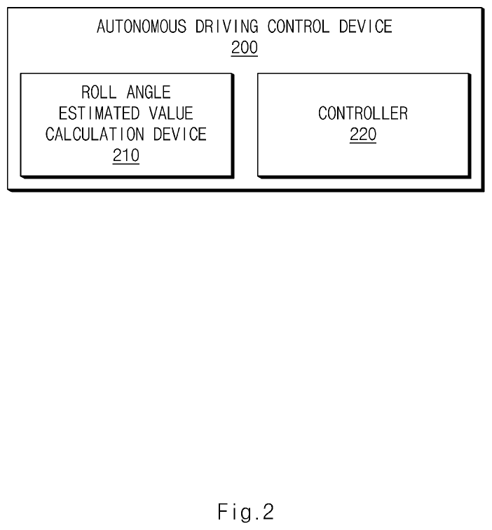

FIG. 2 is a block diagram showing an autonomous driving control device according to an embodiment of the present disclosure.

Referring to FIG. 2, an autonomous driving control device 200 may include a roll angle estimated value calculation device 210 and a controller 220.

As an example, the autonomous driving control device 200 may be formed integrally with the vehicle, may be implemented in a form of being installed in/attached to the vehicle as a component separate from the vehicle, and may be implemented in a form in which a portion thereof is formed integrally with the vehicle, and the remaining portion thereof is installed in/attached to the vehicle as a component separate from the vehicle.

The roll angle estimated value calculation device 210 may calculate a roll angle estimated value of the autonomous vehicle based on a height of a center of gravity of the autonomous vehicle, a sprung mass, a spring constant of a suspension, a target speed, and a target turning radius.

As an example, the roll angle estimated value calculation device 210 may set a speed value input from a user as an initial value of the target speed, may set a minimum turning radius of a preceding section of a road on which the autonomous vehicle is traveling as an initial value of the target turning radius, and may receive feedback of at least one of the target speed and/or the target turning radius from the controller 220.

For example, the roll angle estimated value calculation device 210 may set the target speed based on a logistic transport urgency input from the user through a user interface (UI) such as AVN (Audio, Video, Navigation) and the like as the initial value of the target speed.

As an example, the roll angle estimated value calculation device 210 may set the minimum turning radius of the preceding section of the road on which the autonomous vehicle is traveling identified through road map information and the like as the initial value of the target turning radius.

As an example, the roll angle estimated value calculation device 210 may calculate the roll angle estimated value of the autonomous vehicle to be proportional to a lateral acceleration determined based on the target speed and the target turning radius, the sprung mass, and the height of the center of gravity, and to be inversely proportional to the spring constant.

As an example, the roll angle estimated value calculation device 210 may calculate the roll angle estimated value of the autonomous vehicle through Equation 1 below.

$$ϕ = \frac{{m}_{R} {a}_{y , S} h}{{K}_{R}} . \qquad Equation 1$$

Here, φ may mean the roll angle estimated value of a vehicle body, m_{R} may mean the sprung mass of the vehicle, a_{(y, S)} may mean the lateral acceleration of the vehicle, “h” may mean the height of the center of gravity of the vehicle, and K_{R} may mean the spring constant of the suspension of the vehicle.

As an example, the roll angle estimated value calculation device 210 may obtain the sprung mass via an air suspension pressure sensor of the vehicle.

As an example, the roll angle estimated value calculation device 210 may obtain the height of the center of gravity of the vehicle through a center of gravity height mapping value based on a weight of cargo of the vehicle using vehicle design information.

As an example, the roll angle estimated value calculation device 210 may obtain the spring constant of the suspension through evaluation of spring characteristics of the suspension.

As an example, the roll angle estimated value calculation device 210 may calculate a lateral acceleration a_{(y,S)} of the vehicle through Equation 2 below.

$${a}_{y} = \frac{{V}^{2}}{R} \qquad Equation 2$$

Here, “V” may mean the target speed, and “R” may mean the target turning radius.

As an example, the roll angle estimated value calculation device 210 may be directly or indirectly connected to the controller 220 via wireless or wired communication to transmit information about the calculated roll angle estimated value to the controller 220.

The controller 220 may perform overall control such that each component may normally perform a function thereof. Such controller 220 may be implemented in a form of hardware, implemented in a form of software, or may be implemented in a form of a combination of the hardware and the software. Preferably, the controller 220 may be implemented as a microprocessor, but may not be limited thereto. Further, the controller 220 may perform various data processing, calculations, and the like to be described later.

The controller 220 may compare a roll angle of the autonomous vehicle with a preset reference roll angle to adjust at least one of the target speed and/or the target turning radius of the autonomous vehicle.

In this connection, the reference roll angle may be an angle set to prevent rollover of the vehicle.

As an example, the controller 220 may decrease the target speed when the roll angle estimated value is greater than the reference roll angle, maintain the target speed when the roll angle estimated value is equal to the reference roll angle, and maintain the target speed when the roll angle estimated value is smaller than the reference roll angle.

As an example, when the roll angle estimated value is greater than the reference roll angle, the controller 220 may reduce the target speed to reduce the lateral acceleration of the vehicle because there is a risk of an occurrence of the rollover.

As an example, when the roll angle estimated value is equal to or smaller than the reference roll angle, the controller 220 may maintain the target speed because there is no risk of the occurrence of the rollover.

As an example, the controller 220 may increase the target turning radius when the roll angle estimated value is greater than the reference roll angle and lane change is possible, maintain the target turning radius when the roll angle estimated value is equal to the reference roll angle, and decrease the target turning radius when the roll angle estimated value is smaller than the reference roll angle and the lane change is possible.

As an example, when the roll angle estimated value is greater than the reference roll angle, the controller 220 may increase the target turning radius to decrease the lateral acceleration of the vehicle because there is the risk of the occurrence of the rollover.

As an example, when the roll angle estimated value is equal to or smaller than the reference roll angle, the controller 220 may reduce the target turning radius to maintain the target speed or travel along a minimum route because there is no risk of the occurrence of the rollover.

As an example, the controller 220 may maintain the target turning radius when the lane change is impossible.

As an example, the controller 220 may obtain whether the lane change is possible through surrounding environment information obtained using a radar, a lidar, a camera sensor, and the like of the autonomous vehicle, and maintain the target turning radius when the lane change is impossible.

As an example, the controller 220 may compare the target speed with a speed of the autonomous vehicle to control at least one of a drive torque and/or a braking torque of the autonomous vehicle, or compare the target turning radius with a turning radius corresponding to a current traveling line of the autonomous vehicle to perform lane change control or lane maintenance control of the autonomous vehicle.

As an example, the controller 220 may be connected to an autonomous driving system of the autonomous vehicle or a driving device of the vehicle to perform at least one of drive torque control, braking torque control, lane change control, and/or lane maintenance control.

As an example, the controller 220 may increase the drive torque when the target speed is higher than the speed of the autonomous vehicle, maintain the drive torque when the target speed is equal to the speed of the autonomous vehicle, and decrease the drive torque when the target speed is lower than the speed of the autonomous vehicle.

As an example, the controller 220 may increase the drive torque to increase the speed of the vehicle when the target speed is higher than the speed of the autonomous vehicle, maintain the drive torque to maintain the speed of the vehicle when the target speed is equal to the speed of the autonomous vehicle, and decrease the drive torque to decrease the speed of the vehicle when the target speed is lower than the speed of the autonomous vehicle.

As an example, the controller 220 may increase the braking torque when the target speed is lower than the speed of the autonomous vehicle.

As an example, when the target speed is lower than the speed of the autonomous vehicle, the controller 220 may increase the braking torque to decrease the speed of the vehicle.

As an example, the controller 220 may perform the lane change control in a direction to decrease the turning radius when the target turning radius is smaller than the turning radius corresponding to the current traveling line, perform the lane maintenance control when the target turning radius is equal to the turning radius corresponding to the current traveling line, and perform the lane change control in a direction to increase the turning radius when the target turning radius is larger than the turning radius corresponding to the current traveling line.

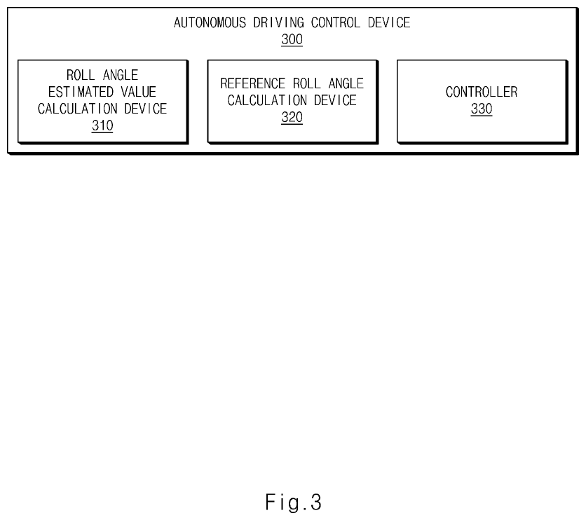

FIG. 3 is a block diagram showing an autonomous driving control device according to another embodiment of the present disclosure.

Referring to FIG. 3, an autonomous driving control device 300 may include a roll angle estimated value calculation device 310, a reference roll angle calculation device 320, and a controller 330.

The roll angle estimated value calculation device 310 and the controller 330 are respectively the same as the roll angle estimated value calculation device 210 and the controller 220 in FIG. 2, so that detailed descriptions thereof will be omitted.

The reference roll angle calculation device 320 may calculate the reference roll angle based on a threshold at which the rollover of the autonomous vehicle occurs, which is determined based on the height of the center of gravity and a wheel tread of the autonomous vehicle.

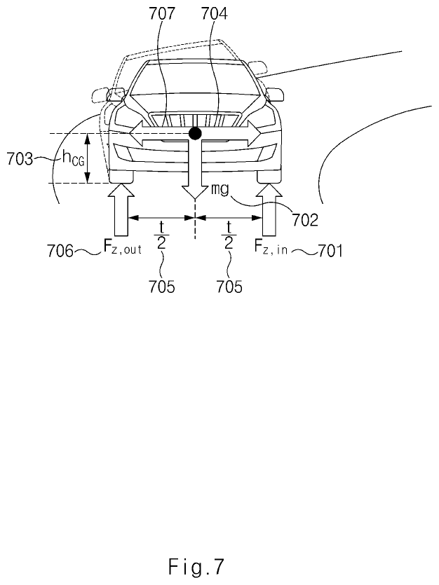

The threshold at which the rollover of the autonomous vehicle occurs will be described in detail in FIG. 7.

As an example, the reference roll angle calculation device 320 may calculate the reference roll angle to be proportional to a preset safety factor and the wheel tread, and to be inversely proportional to the height of the center of gravity.

As an example, the reference roll angle calculation device 320 may calculate the reference roll angle by dividing the wheel tread by the height of the center of gravity, dividing by 2, and multiplying the safety factor.

In this connection, the safety factor may be set to an arbitrary value greater than 1.

As an example, the reference roll angle calculation device 320 may be directly or indirectly connected to the controller 330 via the wireless or wired communication to transmit information about the calculated reference roll angle to the controller 330.

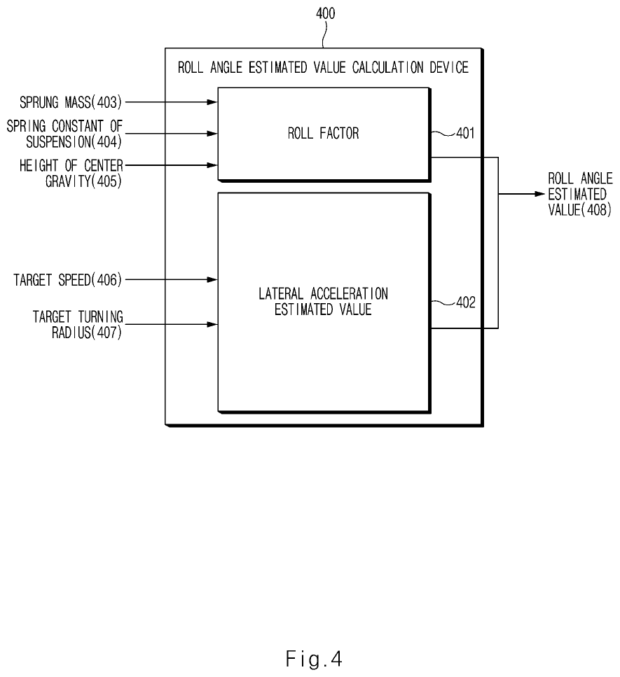

FIG. 4 is a view showing a roll angle estimated value calculation device according to an embodiment of the present disclosure.

Referring to FIG. 4, a roll angle estimated value calculation device 400 may calculate a roll angle estimated value 408 based on a roll factor 401 and a lateral acceleration estimated value 402.

As an example, the roll angle estimated value calculation device 400 may calculate a value obtained by multiplying the roll factor and the lateral acceleration estimated value 402 as the roll angle estimated value 408.

As an example, the roll angle estimated value calculation device 400 may calculate the roll factor 401 based on a sprung mass 403, a spring constant 404 of the suspension, and a height 405 of the center of gravity.

The roll factor 401 may be defined as a value obtained by dividing, by the spring constant 404 of the suspension, a value obtained by multiplying the sprung mass 403 by the height 405 of the center of gravity.

As an example, the roll angle estimated value calculation device 400 may calculate the lateral acceleration estimated value 402 based on a target speed 406 and a target turning radius 407.

As an example, the roll angle estimated value calculation device 400 may calculate a value obtained by dividing a squared value of the target speed 406 by the target turning radius 407 as the lateral acceleration estimated value 402.

As an example, the roll angle estimated value calculation device 400 may obtain the sprung mass 403 through the pressure sensor of the air suspension, may obtain the spring constant 404 of the suspension through the evaluation of the spring characteristics of the suspension, and may obtain the height 405 of the center of gravity through the value of the height of the center of gravity using the vehicle design information mapped based on the weight of the cargo.

As an example, the roll angle estimated value calculation device 400 may receive an initial value of the target speed 406, and may use a feedback value in calculation of a next round.

As an example, the roll angle estimated value calculation device 400 may set an initial value of the target turning radius 407 as the minimum turning radius in the preceding section of the road on which the autonomous vehicle is traveling identified through at least one of the road map information and/or a global positioning system (GPS), and may use a feedback value in calculation of a next round.

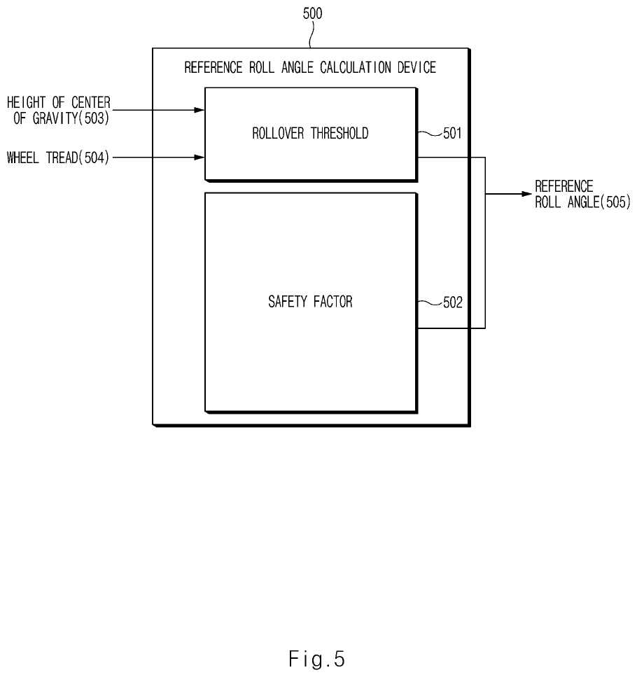

FIG. 5 is a view showing a reference roll angle calculation device according to an embodiment of the present disclosure.

Referring to FIG. 5, a reference roll angle calculation device 500 may calculate a reference roll angle 505 based on a rollover threshold 501 and a safety factor 502.

As an example, the reference roll angle calculation device 500 may calculate a value obtained by multiplying the rollover threshold 501 by the safety factor 502 as the reference roll angle 505.

As an example, the reference roll angle calculation device 500 may calculate the rollover threshold 501 based on a height 503 of the center of gravity of the vehicle and the wheel tread 504.

As an example, the reference roll angle calculation device 500 may calculate the rollover threshold 501 as a value obtained by dividing the wheel tread 504 by a value obtained by multiplying the height 503 of the center of gravity of the vehicle by two.

As an example, the reference roll angle calculation device 500 may obtain the wheel tread 504 of the vehicle through the vehicle design information, and may obtain the height 503 of the center of gravity through the value of the height of the center of gravity using the vehicle design information mapped based on the weight of the cargo.

As an example, the reference roll angle calculation device 500 may calculate the reference roll angle 505 through the preset safety factor 502.

The safety factor 502 may be set to a value greater than 1 and stored in a memory to make the roll angle estimated value differ from the rollover threshold 501 by equal to or more than a certain ratio.

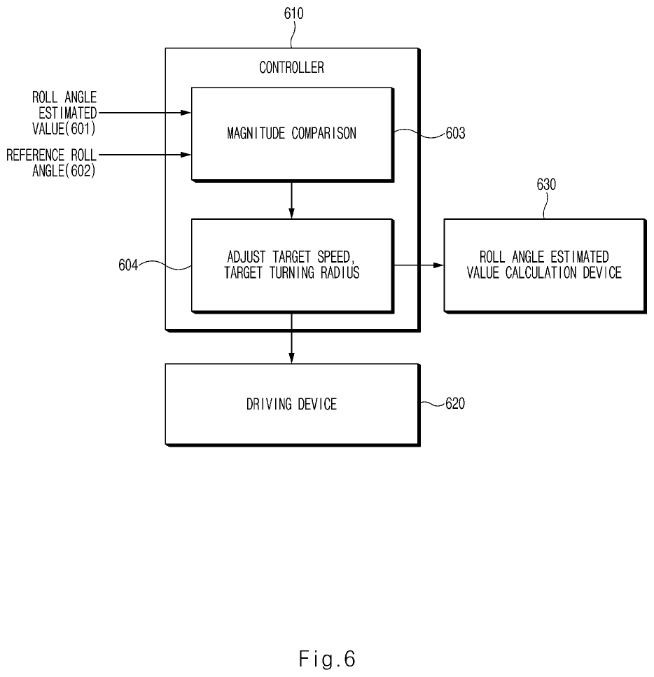

FIG. 6 is a view showing a controller according to an embodiment of the present disclosure.

Referring to FIG. 6, a controller 610 may adjust 604 at least one of the target speed and/or the target turning radius based on a result of magnitude comparison 603 between a roll angle estimated value 601 and a reference roll angle 602.

As an example, the controller 610 may decrease the target speed when the roll angle estimated value 601 is greater than the reference roll angle 602 as the result of the magnitude comparison 603 between the roll angle estimated value 601 and the reference roll angle 602, may maintain the target speed when the roll angle estimated value 601 is equal to the reference roll angle 602, and may maintain the target speed when the roll angle estimated value 601 is smaller than the reference roll angle 602.

As an example, the controller 610 may increase the target turning radius when the roll angle estimated value 601 is greater than the reference roll angle 602 as the result of the magnitude comparison 603 between the roll angle estimated value 601 and the reference roll angle 602 and a lane change is possible, may maintain the target turning radius when the roll angle estimated value 601 is equal to the reference roll angle 602, and may decrease the target turning radius when the roll angle estimated value 601 is smaller than the reference roll angle 602 and a lane change is possible.

The controller 610 may be connected to a driving device 620 of the autonomous vehicle, and perform at least one of acceleration control, deceleration control, lane change control, and/or lane maintenance control of the autonomous vehicle based on at least one of the adjusted target speed and/or target turning radius.

As an example, the controller 610 may be directly connected to the driving device 620 to transmit a control command, and may be indirectly connected to the driving device 620 via the autonomous driving system to transmit the control command.

As an example, the controller 610 may perform at least one of acceleration control, deceleration control, lane change control, and/or lane maintenance control of the autonomous vehicle based on a result of comparison of at least one of the adjusted target speed and/or the target turning radius with at least one of a current speed of the vehicle and/or a turning radius of the preceding section of the line on which the vehicle is currently traveling.

As an example, the controller 610 may perform the acceleration control when the target speed is higher than the speed of the autonomous vehicle, may not perform the acceleration control or the deceleration control when the target speed is equal to the speed of the autonomous vehicle, and may perform the deceleration control when the target speed is lower than the speed of the autonomous vehicle.

As an example, the controller 610 may perform the lane change control in the direction to decrease the turning radius when the target turning radius is smaller than the turning radius corresponding to the current traveling line, may perform the lane maintenance control when the target turning radius is equal to the turning radius corresponding to the current traveling line, and may perform the lane change control in the direction to increase the turning radius when the target turning radius is larger than the turning radius corresponding to the current traveling line.

The controller 610 may be connected to a roll angle estimated value calculation device 630, and may transmit information about at least one of the adjusted target speed and/or the target turning radius to the roll angle estimated value calculation device 630.

As an example, the roll angle estimated value calculation device 630 may feed back at least one of the target speed and/or the target turning radius based on at least one of the received adjusted target speed and/or the target turning radius.

FIG. 7 is a view showing a rollover threshold according to an embodiment of the present disclosure.

The reference roll angle calculation device 320 may calculate a rollover threshold based on a height (h_{CG}) 703 of the center of gravity of the vehicle and a wheel tread “t”.

The rollover threshold may be defined as a limit boundary value at which the vehicle rolls over by rolling.

As forces applied to the vehicle traveling in a turning section, there may be an inward force 704 by the lateral acceleration, a centrifugal force (an inertia force) 707, a vertical force 701 applied to an inner wheel of the vehicle, a gravity 702, and a vertical force 706 applied to an outer wheel of the vehicle.

The vertical force F_{(z,in)} 701 applied to the inner wheel of the vehicle traveling in the turning section and the vertical force F_{(z,out)} 706 applied to the outer wheel may be calculated through Equation 3 below.

$${F}_{z , in} = \frac{mg}{2} - \frac{{h}_{CG} {ma}_{y}}{t} \\ {F}_{z , out} = \frac{mg}{2} + \frac{{h}_{CG} {ma}_{y}}{t} \qquad Equation 3$$

Here, “m” is a mass of the vehicle, “g” is an acceleration of gravity, h_{CG} is the height of the center of gravity of the vehicle, and ay is the lateral acceleration of the vehicle.

In this connection, when the vertical force F_{(z,in)} 701 applied to the inner wheel of the vehicle has a positive value, the rollover of the vehicle occurs. Thus, it is necessary to obtain a condition in which the vertical force F_{(z,in)} 701 applied to the inner wheel of the vehicle becomes 0 to obtain a boundary condition.

The condition in which the vertical force F_{(z,in)} 701 applied to the inner wheel of the vehicle becomes 0 may be obtained through Equation 4 below.

$$∴ \frac{{a}_{y}}{g} = \frac{t}{2 {h}_{CG}} \qquad Equation 4$$

Therefore, a roll angle based on the rollover threshold may be calculated by dividing the wheel tread “t” by a value obtained by multiplying the height (h_{CG}) 703 of the center of gravity of the vehicle by 2.

That is, the reference roll angle calculation device 320 may calculate the roll angle based on the rollover threshold by dividing the wheel tread “t” by the value obtained by multiplying the height (h_{CG}) 703 of the center of gravity of the vehicle by 2.

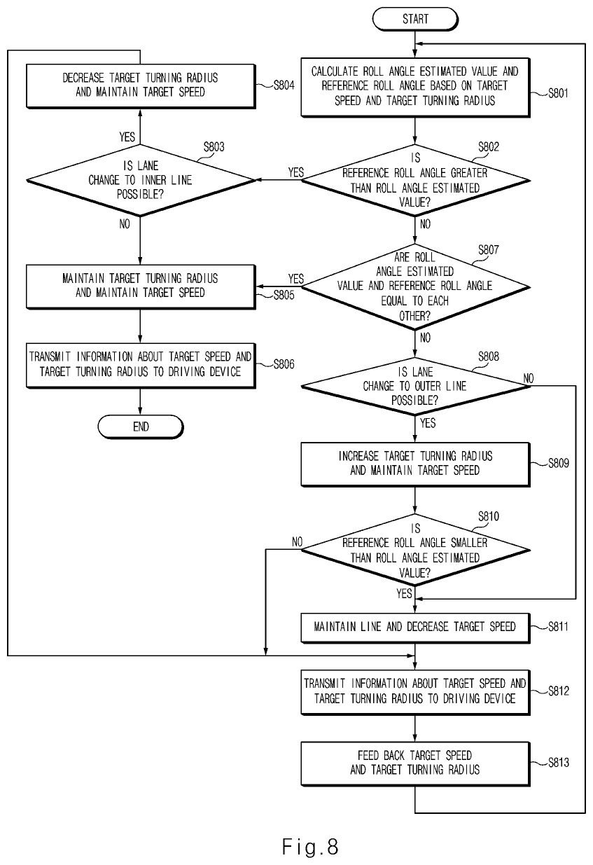

FIG. 8 is a flowchart showing an autonomous driving control method according to an embodiment of the present disclosure.

Hereinafter, it is assumed that the autonomous driving control device 200 in FIG. 2 performs a process in FIG. 8. Further, in a description of FIG. 8, an operation described as being performed by a device may be understood to be controlled by the controller 220 of the autonomous driving control device 200.

Referring to FIG. 8, the autonomous driving control device 200 may calculate the roll angle estimated value and the reference roll angle based on the target speed and the target turning radius (S801).

As an example, the autonomous driving control device 200 may calculate the roll angle estimated value and the reference roll angle based on the target speed, the target turning radius, the height of the center of gravity of the vehicle, the sprung mass, and the spring constant of the suspension.

The autonomous driving control device 200 may calculate the roll angle estimated value and the reference roll angle based on the target speed and the target turning radius (S801), and then determine whether the reference roll angle is greater than the roll angle estimated value (S802).

As an example, the autonomous driving control device 200 may use the reference roll angle calculated by the reference roll angle calculation device 320 in the process of comparing the roll angle estimated value with the reference roll angle.

The autonomous driving control device 200 may determine whether the reference roll angle is greater than the roll angle estimated value (S802), and then, when it is determined that the reference roll angle is greater than the roll angle estimated value (YES at S802), may determine whether lane change to an inner line is possible (S803).

As an example, the autonomous driving control device 200 may determine whether the lane change to the inner line is possible through the radar, the lidar, the camera sensor, and the like equipped in the vehicle.

The autonomous driving control device 200 may determine whether the lane change to the inner line is possible (S803), and then, when it is determined that the lane change to the inner line is possible (YES at S803), may decrease the target turning radius and maintain the target speed (S804).

The autonomous driving control device 200 may determine whether the lane change to the inner line is possible (S803), and then, when it is determined that the lane change to the inner line is not possible (NO at S803), maintain the target turning radius and maintain the target speed (S805), and then transmit the information about the target speed and the target turning radius to the driving device (S806).

The autonomous driving control device 200 may reduce the target turning radius and maintain the target speed (S804), and then transmit information about the target speed and the target turning radius to the driving device (S812).

The driving device may perform speed control or the lane change control of the vehicle based on the information about the target speed and the target turning radius.

The autonomous driving control device 200 may transmit the information about the target speed and the target turning radius to the driving device (S812), and then feed back the target speed and the target turning radius (S813).

As an example, the autonomous driving control device 200 may feed back the target speed and the target turning radius through the roll angle estimated value calculation device 210.

An order of S812 and S813 may be changed. After the process of S813 is performed first, the process of S812 may be performed.

The autonomous driving control device 200 may feed back the target speed and the target turning radius (S813), and then perform the process of S801 again.

The autonomous driving control device 200 may determine whether the reference roll angle is greater than the roll angle estimated value (S802), and then, when it is determined that the reference roll angle is not greater than the roll angle estimated value (NO at S802), determine whether the roll angle estimated value and the reference roll angle are equal to each other (S807).

The autonomous driving control device 200 may determine whether the roll angle estimated value and the reference roll angle are equal to each other (S807), and then, when it is determined that the roll angle estimated value and the reference roll angle are equal to each other (YES at S807), maintain the target turning radius and maintain the target speed (S805).

The autonomous driving control device 200 may maintain the target turning radius and maintain the target speed (S805), and then transmit the information about the target speed and the target turning radius to the driving device (S806).

The autonomous driving control device 200 may determine whether the roll angle estimated value and the reference roll angle are equal to each other (S807), and then, when it is determined that the roll angle estimated value and the reference roll angle are not equal to each other (NO at S807), determine whether lane change to an outer line is possible (S808).

The autonomous driving control device 200 may determine whether the lane change to the outer line is possible (S808), and then, when it is determined that the lane change to the outer line is possible (YES at S808), increase the target turning radius and maintain the target speed (S809).

The autonomous driving control device 200 may determine whether the lane change to the outer line is possible (S808), and then, when it is determined that the lane change to the outside line is not possible (NO at S808), maintain the line and decrease the target speed (S811).

The autonomous driving control device 200 may increase the target turning radius and maintain the target speed (S809), and then determine whether the reference roll angle is smaller than the roll angle estimated value (S810).

The autonomous driving control device 200 may determine whether the reference roll angle is smaller than the roll angle estimated value (S810), and then, when it is determined that the reference roll angle is smaller than the roll angle estimated value (YES at S810), maintain the line and decrease the target speed (S811).

The autonomous driving control device 200 may determine whether the reference roll angle is smaller than the roll angle estimated value (S810), and then, when it is determined that the reference roll angle is not smaller than the roll angle estimated value (NO at S810), transmit the information about the target speed and the target turning radius to the driving device (S812).

The autonomous driving control device 200 may maintain the line and decrease the target speed (S811), and then transmit the information about the target speed and the target turning radius to the driving device (S812) as described above.

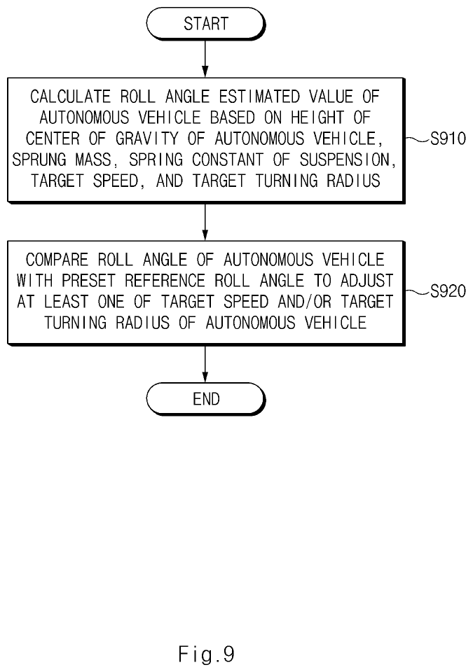

FIG. 9 is a flowchart showing an autonomous driving control method according to another embodiment of the present disclosure.

Hereinafter, it is assumed that the autonomous driving control device 200 in FIG. 2 performs a process in FIG. 9. Further, in a description of FIG. 9, an operation described as being performed by a device may be understood to be controlled by the controller 220 of the autonomous driving control device 200.

Referring to FIG. 9, the method for controlling the autonomous driving may include operation S910 of calculating the roll angle estimated value of the autonomous vehicle based on the height of the center of gravity of the autonomous vehicle, the sprung mass, the spring constant of the suspension, the target speed, and the target turning radius, and operation S920 of comparing the roll angle of the autonomous vehicle with the preset reference roll angle to adjust at least one of the target speed and/or the target turning radius of the autonomous vehicle.

Operation S910 of calculating the roll angle estimated value of the autonomous vehicle based on the height of the center of gravity of the autonomous vehicle, the sprung mass, the spring constant of the suspension, the target speed, and the target turning radius may be performed through the roll angle estimated value calculation device 210.

As an example, operation S910 of calculating the roll angle estimated value of the autonomous vehicle may include an operation of calculating, by the roll angle estimated value calculation device, the roll angle estimated value of the autonomous vehicle to be proportional to the lateral acceleration determined based on the target speed and the target turning radius, the sprung mass, and the height of the center of gravity, and to be inversely proportional to the spring constant.

Operation S920 of comparing the roll angle of the autonomous vehicle with the preset reference roll angle to adjust at least one of the target speed and/or the target turning radius of the autonomous vehicle may be performed through the controller 220.

As an example, S920 of adjusting at least one of the target speed and/or the target turning radius may include an operation of decreasing, by the controller 220, the target speed when the roll angle estimated value is greater than the reference roll angle, an operation of maintaining, by the controller 220, the target speed when the roll angle estimated value is equal to the reference roll angle, and an operation of maintaining, by the controller 220, the target speed when the roll angle estimated value is smaller than the reference roll angle.

As an example, S920 of adjusting at least one of the target speed and/or the target turning radius may include an operation of increasing, by the controller 220, the target turning radius when the roll angle estimated value is greater than the reference roll angle and the lane change is possible, an operation of maintaining, by the controller 220, the target turning radius when the roll angle estimated value is equal to the reference roll angle, an operation of decreasing, by the controller 220, the target turning radius when the roll angle estimated value is smaller than the reference roll angle and the lane change is possible, and an operation of maintaining, by the controller 220, the target turning radius when the lane change is not possible.

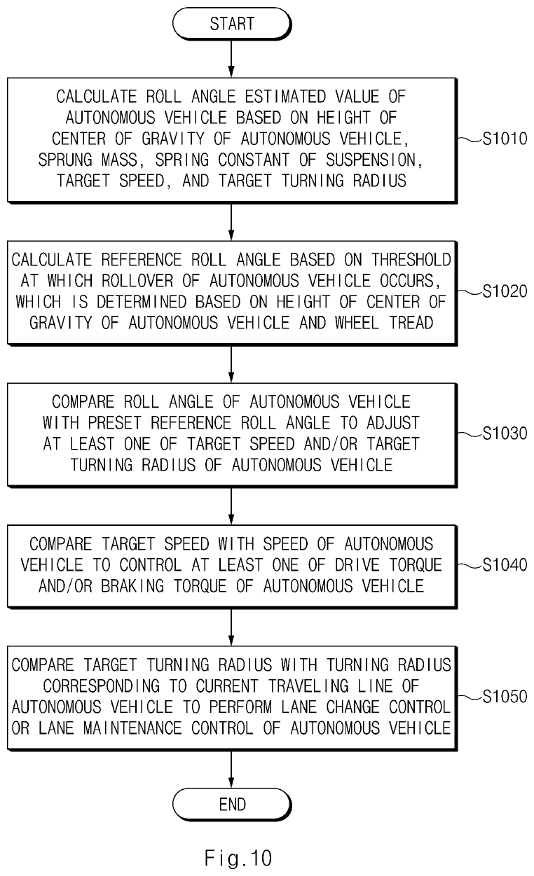

FIG. 10 is a flowchart showing an autonomous driving control method according to another embodiment of the present disclosure.

Hereinafter, it is assumed that the autonomous driving control device 200 in FIG. 2 performs a process in FIG. 10. Further, in a description of FIG. 10, an operation described as being performed by a device may be understood to be controlled by the controller 220 of the autonomous driving control device 200.

Referring to FIG. 10, the method for controlling the autonomous driving may include operation S1010 of calculating the roll angle estimated value of the autonomous vehicle based on the height of the center of gravity of the autonomous vehicle, the sprung mass, the spring constant of the suspension, the target speed, and the target turning radius, operation S1020 of calculating the reference roll angle based on the threshold at which the rollover of the autonomous vehicle occurs, which is determined based on the height of the center of gravity of the autonomous vehicle and the wheel tread, operation S1030 of comparing the roll angle of the autonomous vehicle with the preset reference roll angle to adjust at least one of the target speed and/or the target turning radius of the autonomous vehicle, operation S1040 of comparing the target speed with the speed of the autonomous vehicle to control at least one of the drive torque and/or the braking torque of the autonomous vehicle, and operation S1050 of comparing the target turning radius with the turning radius corresponding to the current traveling line of the autonomous vehicle to perform the lane change control or the lane maintenance control of the autonomous vehicle.

S1010 and S1030 are the same as S910 and S920 in FIG. 9, respectively, so that detailed descriptions thereof will be omitted.

Operation S1020 of calculating the reference roll angle based on the threshold at which the rollover of the autonomous vehicle occurs, which is determined based on the height of the center of gravity and the wheel tread of the autonomous vehicle, may be performed through the reference roll angle calculation device 320.

As an example, operation S1020 of calculating the reference roll angle may include an operation of calculating, by the reference roll angle calculation device 320, the reference roll angle to be proportional to the preset safety factor and the wheel tread and to be inversely proportional to the height of the center of gravity.

Operation S1040 of comparing the target speed with the speed of the autonomous vehicle to control at least one of the drive torque and/or the braking torque of the autonomous vehicle may be performed through the controller 220.

As an example, operation S1040 of controlling at least one of the drive torque and/or the braking torque of the autonomous vehicle may include an operation of increasing, by the controller 220, the drive torque when the target speed is higher than the speed of the autonomous vehicle, an operation of maintaining, by the controller 220, the drive torque when the target speed is equal to the speed of the autonomous vehicle, and an operation of decreasing, by the controller 220, the drive torque or increasing the braking torque when the target speed is lower than the speed of the autonomous vehicle.

Operation S1050 of comparing the target turning radius with the turning radius corresponding to the current traveling line of the autonomous vehicle to perform the lane change control or the lane maintenance control of the autonomous vehicle may be performed through the controller 220.

As an example, operation S1050 of performing the lane change control or the lane maintenance control of the autonomous vehicle may include an operation of performing, by the controller 220, the lane change control in the direction to decrease the turning radius when the target turning radius is smaller than the turning radius corresponding to the current traveling line, an operation of performing, by the controller 220, the lane maintenance control when the target turning radius is equal to the turning radius corresponding to the current traveling line, and an operation of performing, by the controller 220, the lane change control in the direction to increase the turning radius when the target turning radius is greater than the turning radius corresponding to the current traveling line.

The operations of the method or the algorithm described in connection with the embodiments disclosed herein may be embodied directly in hardware or a software module executed by the processor, or in a combination thereof. The software module may reside on a storage medium (that is, the memory and/or the storage) such as a RAM, a flash memory, a ROM, an EPROM, an EEPROM, a register, a hard disk, a removable disk, and a CD-ROM.

The exemplary storage medium may be coupled to the processor, and the processor may read information out of the storage medium and may record information in the storage medium. Alternatively, the storage medium may be integrated with the processor. The processor and the storage medium may reside in an application specific integrated circuit (ASIC). The ASIC may reside within a user terminal. In another case, the processor and the storage medium may reside in the user terminal as separate components.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

Therefore, the exemplary embodiments of the present disclosure are provided to explain the spirit and scope of the present disclosure, but not to limit them, so that the spirit and scope of the present disclosure is not limited by the embodiments. The scope of the present disclosure should be construed on the basis of the accompanying claims, and all the technical ideas within the scope equivalent to the claims should be included in the scope of the present disclosure.

Various effects of the device and the method for controlling the autonomous driving according to embodiments of the present disclosure will be described as follows.

At least one of the embodiments of the present disclosure may provide the device and the method for controlling the autonomous vehicle for the logistics transportation.

Further, at least one of the embodiments of the present disclosure may provide the device and the method for controlling the autonomous vehicle that may calculate the roll angle of the autonomous vehicle for the logistics transportation to perform the autonomous driving that secures the vehicle overturning stability.

Further, at least one of the embodiments of the present disclosure may provide the device and the method for controlling the autonomous vehicle that may perform the lateral or the longitudinal autonomous driving control of the vehicle based on the roll angle of the autonomous vehicle to promote an increase in the energy efficiency and a reduction of the transportation time.

Further, at least one of the embodiments of the present disclosure may provide the device and the method for controlling the autonomous vehicle that may reduce the logistics cost through the increase in the energy efficiency and the reduction in the transportation time of the autonomous vehicle for the logistics transportation.

Further, at least one of the embodiments of the present disclosure may provide the device and the method for controlling the autonomous vehicle that may allow the autonomous vehicle to maintain the minimum turning radius in the rolling safe region when traveling at the turning reference speed to ensure the minimum traveling distance, thereby promoting the logistics cost optimization together with the speed limitation.

In addition, various effects that are directly or indirectly identified through the present disclosure may be provided.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling autonomous driving, the device comprising:
a roll angle estimated value calculation device configured to calculate a roll angle estimated value of a vehicle based on a height of a center of gravity of the vehicle, a sprung mass, a spring constant of a suspension, a target speed, and a target turning radius; and
a controller configured to compare a roll angle of the vehicle with a preset reference roll angle to adjust at least one of the target speed or the target turning radius of the vehicle.

2. The device of claim 1, further comprising a reference roll angle calculation device configured to calculate a reference roll angle based on a threshold of rollover of the vehicle determined based on the height of the center of gravity and a wheel tread of the vehicle.

3. The device of claim 2, wherein the reference roll angle calculation device is configured to calculate the reference roll angle to be proportional to a preset safety factor and the wheel tread and to be inversely proportional to the height of the center of gravity.

4. The device of claim 1, wherein the controller is configured to:
decrease the target speed in response to the roll angle estimated value being greater than a reference roll angle;
maintain the target speed in response to the roll angle estimated value being equal to the reference roll angle; and
maintain the target speed in response to the roll angle estimated value being smaller than the reference roll angle.

5. The device of claim 1, wherein the controller is configured to:
increase the target turning radius in response to the roll angle estimated value being greater than a reference roll angle and a lane change being possible;
maintain the target turning radius in response to the roll angle estimated value being equal to the reference roll angle; and
decrease the target turning radius in response to the roll angle estimated value being smaller than the reference roll angle and the lane change being possible.

6. The device of claim 1, wherein the controller is configured to maintain the target turning radius in a case in which a lane change is not possible.

7. The device of claim 1, wherein the roll angle estimated value calculation device is configured to:
set a speed value input from a user as an initial value of the target speed;
set a minimum turning radius of a preceding section of a traveling road of the vehicle as an initial value of the target turning radius; and
receive feedback of at least one of the target speed or the target turning radius from the controller.

8. The device of claim 1, wherein the roll angle estimated value calculation device is configured to calculate the roll angle estimated value of the vehicle to be proportional to a lateral acceleration determined based on the target speed and the target turning radius, the sprung mass, and the height of the center of gravity, and to be inversely proportional to the spring constant.

9. A device for controlling autonomous driving, the device comprising:
a roll angle estimated value calculation device configured to calculate a roll angle estimated value of a vehicle based on a height of a center of gravity of the vehicle, a sprung mass, a spring constant of a suspension, a target speed, and a target turning radius; and
a controller configured to:
compare a roll angle of the vehicle with a preset reference roll angle to adjust at least one of the target speed or the target turning radius of the vehicle; and
compare the target speed with a speed of the vehicle to control a drive torque or a braking torque of the vehicle or compare the target turning radius with a turning radius corresponding to a current traveling line of the vehicle to perform lane change control or lane maintenance control of the vehicle.

10. The device of claim 9, wherein the controller is configured to:
increase the drive torque in response to the target speed being higher than the speed of the vehicle;
maintain the drive torque in response to the target speed being equal to the speed of the vehicle; and
reduce the drive torque in response to the target speed being lower than the speed of the vehicle.

11. The device of claim 9, wherein the controller is configured to increase the braking torque in response to the target speed being lower than the speed of the vehicle.

12. The device of claim 9, wherein the controller is configured to:
perform the lane change control in a direction to decrease the turning radius in response to the target turning radius being smaller than the turning radius corresponding to the current traveling line;
perform the lane maintenance control in response to the target turning radius being equal to the turning radius corresponding to the current traveling line; and
perform the lane change control in a direction to increase the turning radius in response to the target turning radius being larger than the turning radius corresponding to the current traveling line.

13. A method for controlling autonomous driving, the method comprising:
calculating a roll angle estimated value of a vehicle based on a height of a center of gravity of the vehicle, a sprung mass, a spring constant of a suspension, a target speed, and a target turning radius; and
adjusting at least one of the target speed or the target turning radius of the vehicle by comparing a roll angle of the vehicle with a preset reference roll angle.

14. The method of claim 13, further comprising calculating a reference roll angle based on a threshold of rollover of the vehicle determined based on the height of the center of gravity and a wheel tread of the vehicle.

15. The method of claim 14, wherein:
calculating the roll angle estimated value of the vehicle comprises calculating the roll angle estimated value of the vehicle to be proportional to a lateral acceleration determined based on the target speed and the target turning radius, the sprung mass, and the height of the center of gravity, and to be inversely proportional to the spring constant; and
calculating the reference roll angle comprises calculating the reference roll angle to be proportional to a preset safety factor and the wheel tread, and to be inversely proportional to the height of the center of gravity.

16. The method of claim 13, wherein adjusting at least one of the target speed or the target turning radius of the vehicle comprises:
decreasing the target speed in response to the roll angle estimated value being greater than a reference roll angle;
maintaining the target speed in response to the roll angle estimated value being equal to the reference roll angle; and
maintaining the target speed in response to the roll angle estimated value being smaller than the reference roll angle.

17. The method of claim 13, wherein adjusting at least one of the target speed or the target turning radius of the vehicle comprises:
increasing the target turning radius in response to the roll angle estimated value being greater than a reference roll angle and a lane change being possible;
maintaining the target turning radius in response to the roll angle estimated value being equal to the reference roll angle;
decreasing the target turning radius in response to the roll angle estimated value being smaller than the reference roll angle and the lane change being possible; and
maintaining the target turning radius in response to the lane change not being possible.

18. The method of claim 13, further comprising:
comparing the target speed with a speed of the vehicle to control at least one of a drive torque or a braking torque of the vehicle; or
comparing the target turning radius with a turning radius corresponding to a current traveling line of the vehicle to perform lane change control or lane maintenance control of the vehicle.

19. The method of claim 18, wherein controlling at least one of the drive torque or the braking torque of the vehicle comprises:
increasing the drive torque in response to the target speed being higher than the speed of the vehicle;
maintaining the drive torque in response to the target speed being equal to the speed of the vehicle; and
reducing the drive torque or increasing the braking torque in response to the target speed being lower than the speed of the vehicle.

20. The method of claim 18, wherein performing the lane change control or the lane maintenance control of the vehicle comprises:
performing the lane change control in a direction to decrease the turning radius in response to the target turning radius being smaller than the turning radius corresponding to the current traveling line;
performing the lane maintenance control in response to the target turning radius being equal to the turning radius corresponding to the current traveling line; and
performing the lane change control in a direction to increase the turning radius in response to the target turning radius being larger than the turning radius corresponding to the current traveling line.
